(19) United States
(12) Patent Application Publication
(10) Pub. No.: US 2025/0377743 A1
(43) Pub. Date: Dec. 11, 2025

(54) ERGONOMIC SUPPORT DEVICE

(71) Applicant: FELLOWES, INC., Itasca, IL (US)

(72) Inventors: Michael EGAN, Chicago, IL (US); Tai Hoon K. MATLIN, Round Lake Beach, IL (US)

(21) Appl. No.: 19/038,608

(22) Filed: Jan. 27, 2025

Related U.S. Application Data
(60) Provisional application No. 63/656,160, filed on Jun. 5, 2024.

(51) Int. Cl. G06F 3/039; A47B 97/00

(52) U.S. Cl. CPC G06F 3/0395; A47B 97/00; A47B 2200/0091; A47B 2200/0095

(57) ABSTRACT

A wrist rest device for use with a manually operated computer input device is provided. The wrist rest device comprising a wrist support formed of deformable material for providing resilient support to a user's wrist. The wrist support has an upper wall and forward and rearward edge portions extending in a lateral direction. A frame has a wrist support receiving space for receiving and removably securing the wrist support to the frame. The frame engages at least the forward and rearward edge portions of the wrist support to prevent deflection of the edge portions away from one another. Other types of ergonomic support devices comprising a body part support may also be practiced.

The present application claims priority to U.S. Provisional Appln. Ser. No. 63/656,160, filed Jun. 5, 2024, the entirety of which is hereby incorporated by reference for all purposes.

### FIELD

The present application relates to a wrist rest for use with a manually operated computer input device. The present application also relates to other support devices for ergonomic support of a user's body part, which may be in different fields.

### BACKGROUND

The inventors of the present application have endeavored to address challenges with the design of wrist rest devices, including but not limited to making the disposal of the device more environmentally friendly, providing enhanced wrist/hand support, and/or making the device more compact for easier storage, placement in a lap top bag, or the like. Current wrist rest devices generally have not addressed these concerns well. For example, they are generally designed to be long-lasting (which tends to rely on materials that are more difficult to recycle or that may not be amenable to multiple use/recyclings). Wrist rest devices are also generally designed without storage/size in mind during non-use as leaving them on a desktop is less of a concern. However, with partial in-office weeks on the rise, e.g., 3 days in 2 days remote, storage/size becomes an issue for more desk workers, as opposed to just those with routine travel and other such arrangements that lead them to change between the office and other locations.

Examples of prior art wrist rests include U.S. Pat. Nos. 5,562,270, 5,713,544, U.S. Patent Publication Nos. 2011/0309212, 2012/0061546, 2014/0083336 Korean Patent Application Nos. KR20190009622A, KR20140099839A, and Chinese Patent CN105353899B, each of which is incorporated herein by reference.

### SUMMARY

One aspect of the present invention provides an ergonomic support device comprising a body part support formed of deformable material for providing resilient support to a user's body part. The body part support has an upper wall and forward and rearward edge portions extending in a lateral direction. A frame has a body part support receiving space for receiving and removably securing the body part support to the frame, with the frame engaging at least the forward and rearward edge portions of the body part support to prevent deflection of the edge portions away from one another. The device may be a wrist rest device for use with a manually operated computer input device, where the body part support is a wrist support formed of the deformable material and the receiving space is a wrist rest receiving space.

Another aspect of the present application provides a wrist rest device for use with a manually operated computer input device. The device comprises a wrist support formed of deformable material for providing resilient support to a user's wrist. The wrist support has an upper wall for engaging the wrist and also has forward and rearward walls extending in a lateral direction with forward and rearward edge portions. The wrist support further comprises a plurality of vertical members extending downwardly from the upper wall in an interior of the wrist support between the forward and rearward wall. The vertical members are configured to engage a work surface on which the wrist support is placed to resist downward deflection of the upper wall.

In some embodiments, the vertical members are cell walls forming a plurality of columnar cell structures open to a bottom of the wrist support. One or more of cell walls in some embodiments may be provided with an air passage to permit air to escape from a cell interior as the wrist support is compressed downward and/or to permit air to enter the cell interior as the wrist support rebounds upwardly.

In some embodiments, the plurality of vertical members may be tapered, with a thicker upper portion connected to the upper wall and a thinner lower portion that has the bottom edge that engage the work surface. The tapering of the vertical members may be configured to provide a gradual increase in resistance to downward deflection of the upper wall wherein a bending focus gradually rises such that the bending occurs at higher points on the cell walls, which are increasingly thicker.

In some embodiments, the plurality of vertical members extend downwardly from the upper wall such that when the upper wall is undeflected the vertical members are spaced upwardly from a bottom plane of the wrist support so as to be spaced above the work surface. The bottom edges of the vertical member may optionally follow a curved or arched shape.

In some embodiments, the plurality of vertical members may include two or more parallel walls within the wrist support interior that extend parallel to the forward and rearward walls. The parallel walls are connected to the inner surface of the upper wall for additional support against deflection of the upper wall.

In some embodiments, the vertical members may also extend below a bottom plane of the wrist support such that when the wrist support is placed on a work surface the vertical members are pretensioned under bending stress.

In some embodiments, the plurality of vertical members are a plurality of ribs extending downwardly from the upper wall, wherein the ribs are configured to deflect to provide resilient support against the downward deflection of the upper wall. The ribs may optionally be arranged in rows parallel to the forward and rearward walls such that each adjacent pair of rows has the ribs staggered or offset with respect to the other in the direction parallel to the forward and rearward walls.

Another aspect of the present application provides a collapsible wrist rest device. The device comprises a base having an upper surface and a bottom surface for engaging a work surface and supporting the wrist rest device. A wrist support is formed of a sheet material. At least one retention structure is provided on the upper surface of the base for engaging at least one free edge of the wrist support. The at least one retention structure is positioned such that engagement of the at least one free edge therewith pre-tensions the wrist support in a bowed configuration to provide resilient support to a user's wrist. The at least one free edge of the wrist support can be disengaged from the at least one retention structure to allow the wrist support to assume a substantially flatter configuration for collapsing of the wrist rest device.

Other objects, features and advantages of the present application will become apparent from the following detailed description, the accompanying drawings, and the appended claims.

### BRIEF DESCRIPTION OF DRAWINGS

FIG. 1 is a perspective view of a layout including two different wrist rest devices according to the present application;

FIG. 2 is upper and lower views of an embodiment of a wrist rest device with a mouse pad, as well as an exploded view showing the components thereof;

FIG. 3 provides a cross-sectional view and a perspective cross-sectional view of a wrist rest device according to another embodiment;

FIG. 4 is a perspective bottom view of the device of FIG. 3;

FIG. 5 schematically illustrates differences in deflection behavior of the device of FIG. 3, as well as other embodiments;

FIG. 6 is a bottom perspective view of two variations of the wrist support in the device of FIG. 3;

FIG. 7 is a perspective bottom view of another embodiment;

FIG. 8 is a modification of the embodiment in FIG. 7;

FIG. 8A is a modification of the FIG. 8 embodiment, which also may be applied to other embodiments;

FIGS. 9A-C show another embodiment of a wrist rest device;

FIG. 10 shows the frame used in FIGS. 9A-C in isolation;

FIG. 11 is a schematic plan view illustrating use of a filler material for additional support in any embodiment;

FIG. 12 is a perspective bottom view of another embodiment of a wrist rest device;

FIG. 13 is a perspective bottom view of another embodiment of a wrist rest device;

FIG. 14 is a perspective bottom view of another embodiment of a wrist rest device;

FIG. 15 is a perspective exploded view of another embodiment of a wrist rest device;

FIGS. 16A and 16B are cross-sectional views of the device of FIG. 15;

FIG. 17 is a perspective view and a cross-section thereof of another embodiment of a wrist rest device as a standalone version;

FIG. 18 is a plan view showing different implementations of wrist rest devices;

FIG. 19 is a perspective view of another embodiment of a wrist rest device;

FIG. 20 is a perspective view of an embodiment similar to FIG. 19, but as a stand-alone version;

FIG. 21 is perspective view of another embodiment of a wrist rest device;

FIG. 22 is a perspective view showing two wrist rest devices made in accordance with FIG. 19 or 21;

FIG. 23 is a bottom perspective view showing an interlocking features for securing two wrist rest devices together;

FIG. 24 is a cross-sectional view showing another interlocking feature for securing two wrist rest devices together;

FIG. 25 includes perspective views of another embodiment of a wrist rest device.

### DETAILED DESCRIPTION OF THE ILLUSTRATED EMBODIMENT(S)

The present application provides a wrist rest device 10 for use with a manually operated computer input device, such as a mouse 12 or a keyboard 14. The wrist rest device 10 comprises a wrist support 16 formed of deformable material for providing resilient support to a user's wrist.

Various embodiments are disclosed herein, and common reference numbers will be used for structures of common type. Where a common reference number with a letter is used (e.g., 10, 10a, 10b, etc.), that likewise denotes a structure of common type. Structure of common type, however, does not mean the exact same structure must be used, and variations are intended to be included for that structure, and is simply of the same general type and is not necessarily limited to the same structure. Reference numbers in the drawings of the same type (e.g., 58d) may not appear in the specification, but the understanding is that they denote the same or variations of the same general structure as the common reference number which are mentioned elsewhere in the specification.

Each wrist support 16 has an upper wall 18 and forward and rearward edge portions 20, 22 extending in a lateral direction. For a device designed to be used in a particular orientation, the terms forward and rearward edge portions 20, 22 refer to the direction of intended use, which is readily understood by a person of ordinary skill in the art. The forward edge portion refers to the portion adjacent the edge away from the user and the rearward edge portion refers to the portion adjacent the edge closer to the user, i.e., the direction in which the wrist and forearm generally extends away in. For example, in the devices discussed herein with a pad for supporting a mouse 12 or keyboard 14, the pad extends in the forward direction and the wrist support 16 is located rearwardly thereof. For devices where the use orientation is arbitrary, such as a wrist rest device that is a standalone device and thus can be used with either edge in the front or rear, the terms forward and rearward should be treated as terms of convenience to differentiate one edge portion from the other and may also be interpreted as first and second edge portions. The same applies to other references to the forward and rearward directions of variants thereof (like front and back). Similarly, lateral is the direction cross-wise to the forward/rearward direction, and the same applies to variations there, with terms like right and left referring to the lateral direction. These directional references apply unless the context dictates otherwise, e.g. a reference to something being at a particular location in a Figure rather than in reference to the device itself.

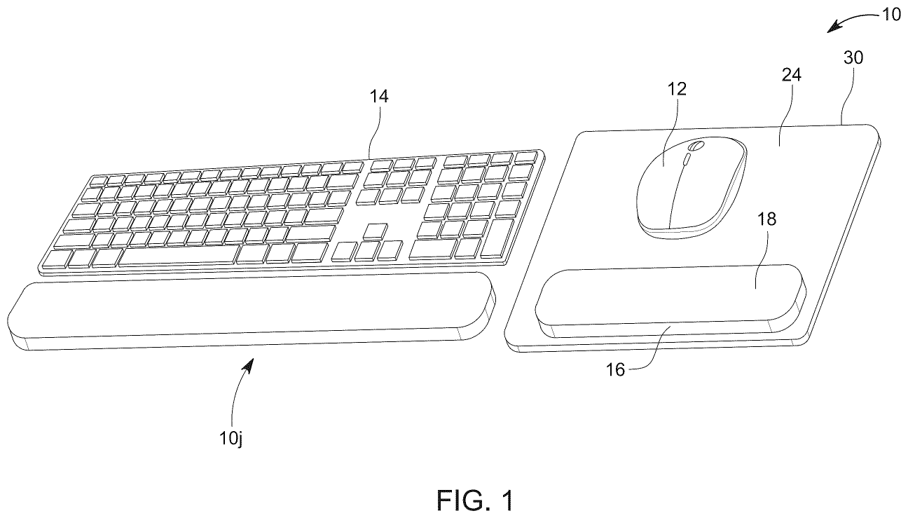

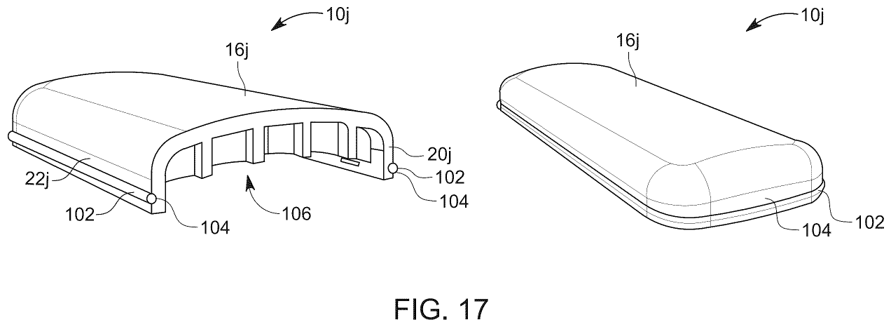

FIG. 1 shows a layout including two different wrist rest devices 10, 10j. Wrist rest device 10 is of the type with a device support pad 30 (in this case a mouse pad) extending forwardly away from the wrist support 16 for supporting the computer input device, specifically a mouse 12, thereon. Wrist rest device 10j is of the standalone type, an example of which is discussed below with respect to FIG. 17. A standalone device has no such pad and is simply placed on a work surface so as to extend laterally in front of the keyboard 14 or other input device. In some embodiments, the wrist rest device may also include a pad for supporting the keyboard 14 in a manner similar to wrist rest device 10 (albeit sized to accommodate a keyboard 14).

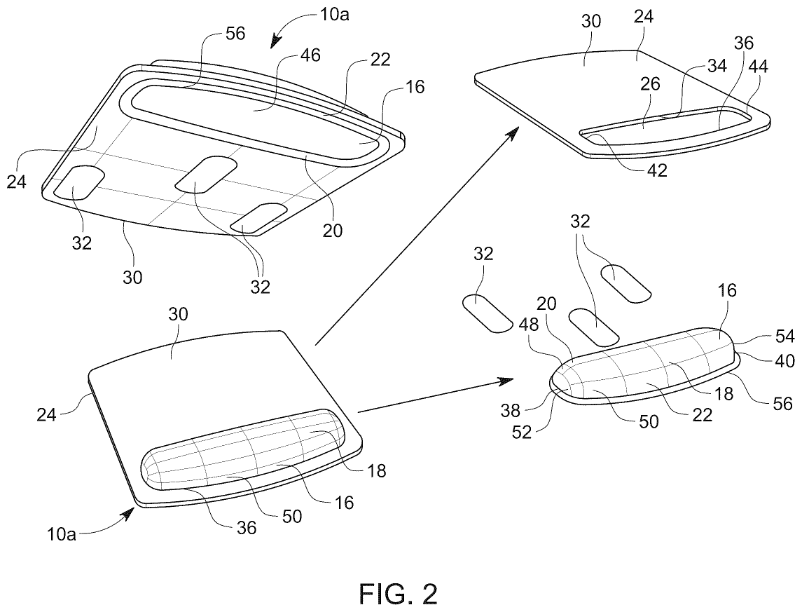

FIG. 2 shows upper and lower perspective views of one example of a wrist rest device 10a with a mouse pad 30, as well as an exploded view showing the components thereof. The wrist rest device 10a includes a frame 24 that has a wrist support receiving space 26 for receiving and removably securing the wrist support 16 to the frame 24. The frame 24 includes the mouse pad 30 as an integral component thereof and has an optional set of anti-slip feet or pads 32 attached to the bottom thereof, such as by adherence, fusing, overmolding, mechanical fastening, snap-fit mounting, or any other suitable type of attachment. In the illustrated embodiment, the frame 24 is made of ABS, which is a plastic that is more rigid than the wrist support 16 material and provides structural support for mounting the wrist support 16. Because ABS or other similar materials that are more rigid tend to slide more easily on a desk surface, the optional anti-slip feet or pads 32 help prevent such sliding. The class of anti-slip materials for the feet or pads is well-known, and includes more low hardness materials resistant to slipping as may occur during mouse usage. Examples of materials for those optional feet/pads 32 include TPE and TPE. Such materials typically have a hardness in the range of 10 Shore 00 to 70 Shore A, with a preferred range of 25-55 Shore A.

The frame 24 material can be made from materials other than ABS which are more rigid than the wrist support 16 material. Materials with a Shore D durometer above 0, including between 0-110 and more preferably in the range of 70-100 are typically used for such a frame 24. For example, ABS is typically in the range of 70-103 Shore D with an average of 87.

The frame 24 engages at least the forward and rearward edge portions 20, 22 of the wrist support 16 to prevent deflection of the edge portions away from one another. In the non-limiting design of FIG. 2, and other designs with similar constructions as discussed herein, the wrist support receiving space 26 has a shape corresponding to the bottom footprint of the wrist support 16 with forward and rearward edges 34, 36 that correspond to the forward and rearward edge portions 20, 22 of the wrist support 16. The wrist support also has opposing lateral edges 38, 40 and the space 26 has corresponding lateral edges 42, 44 in the non-limiting configuration.

As previously mentioned, the wrist support 16 is formed of deformable material for providing resilient support to a user's wrist. The deformable material may be of any type, and the term deformable in this context means the material will resiliently deflect under the weight of a human's wrist resting thereof. This provides comfort and also supports the wrist elevated off the work surface for better ergonomic position when operating the computer input device, e.g, the mouse 12 or keyboard 14. Likewise, the material preferably has sufficient rigidity to avoid collapsing down too far. The material for wrist support 16 may be of any type, and TPU is the example material used in the illustrated non-limiting design of FIG. 2. Other examples of such materials include: TPE blends, silicone, and rubber. Such materials typically have a hardness in the range of 20 Shore A to 60 Shore A, with a preferred ranges of 30-50 Shore A or 40-50 Shore A.

In the embodiment of FIG. 2, the interior of the wrist support 16 is hollow; that is, it has an open bottom with a downwardly concave space 46 therein. The upper wall 18 in this embodiment is the upper region where the user places his/her wrist, and the support 16 also includes a forward wall 48, a rearward wall 50, and opposing lateral end walls 52, 54. The bottom peripheral edge has a flange or lip 56 extending along the periphery thereof. The flange or lip 56 may extend continuously all the way around as shown, or a series of spaced apart flanges or lips 56 may be used. Likewise, the flanges or lips may be limited to just the forward and rearward edges in some embodiments. The wrist support 16 may be formed as one integral piece, such as by injection molding. The forwards, rearward, and lateral walls need to be completely vertical or angularly distinct from the upper wall 18. For example, these walls could smoothly transition into the upper wall 18. Thus, the support 16 can also have domed, ovular or other such cross-sections, with the upper wall 18 being the upwardly facing portion thereof and the other portions extending more downward being the other walls.

The wrist support 16 is inserted into the wrist support receiving space 26 of the frame 24. Thus, the forward and rearward edge portions 20, 22 of the wrist support 16 engage the forward and rearward edges 34, 36 of the wrist receiving space 26. This prevents the forward and rearward edge portions 20, 22 from spreading apart from one another as the wrist support 16 deforms under the weight of a user's wrist (also called splaying). This helps manage the deformation to the portion thereof exposed above the frame 24, and also keeps the support walls, and particularly the forward and rearward walls 48, 50 in a more vertical orientation at a better angle for support, which thus manages the deformation so it occurs more so by the upper wall 18 deflecting.

In the design of FIG. 2, the flange or lip 56 of the wrist support 16 is positioned to engage the bottom surface of the frame 24 around the periphery of the space 26. This removably secures the support 16 to the frame 24. Given that the user's hand typically rests on the mouse 12 when being used, the frame 24 itself generally does not lift (assuming normal usage), and thus the wrist support 16 is effectively secured from the bottom as well. With this design, the wrist support can easily be removed, particularly if the user wishes to store the wrist rest device 10 or pack it in a laptop bag or the like for travel. In other designs, as discussed herein, the removable securement may be affected by snap-fitting, or other approaches like snap-fitting, friction or interference fitting, lighter strength adhesive bonding, pinning, or any other fastening approach that allows for separation may be used.

The separability of the wrist support 16 from the frame 24, which are made from different materials, also has other non-limiting advantages. For example, if the wrist support 16 material gets worn, damaged, the user otherwise wants to replace it, the ability to separate it from the frame 24 without damage to the frame allows the frame 24 to be re-used. Also, certain materials considered to be biodegradeable or compostable may be used for the wrist support 16 (i.e., as the deformable material from which it is made), which has the advantage of being disposable in an environmentally friendly manner, but some of them may require replacement more often (including the less expensive ones). Thus, the ability to replace the wrist support 16 could beneficially be part of an environmentally friendly materials strategy. Similarly, if the whole device 10 is to be discarded, if the frame 24 is not also biodegradable or compostable but is recyclable, it can be discarded for recycling while the wrist support 16 can be composted or thrown away in any manner where it can biodegrade (or vice versa).

As another example, if both parts are recyclable, but of different materials, they can be separated for disposal in the respective recycling “streams” for programs that separate different recycling materials. A stream is a term referring to separation of materials into different categories or types that can be recycled together. As one example, metal and plastics are often put in separate bins in everyday settings because they are recycled by different processes, and sometimes all recyclable materials are disposed of in the same bin in single stream recycling. Similarly, certain types of plastics may be recycled (or may be recycled more efficiently or effectively) by one process or series of processes, whereas a different process or series of processes may be better suited to other types of plastics. Hence, those different plastics could be separated from one another, i.e., as two different streams for input into the respective processes. As one example, if the manufacturer of the wrist rest device 10 (or someone else) accepts recycling returns, it may be able to separate the frames 24 and the wrist supports 16 from one another prior to delivery to a recycling operator or operators so they can be recycled separately.

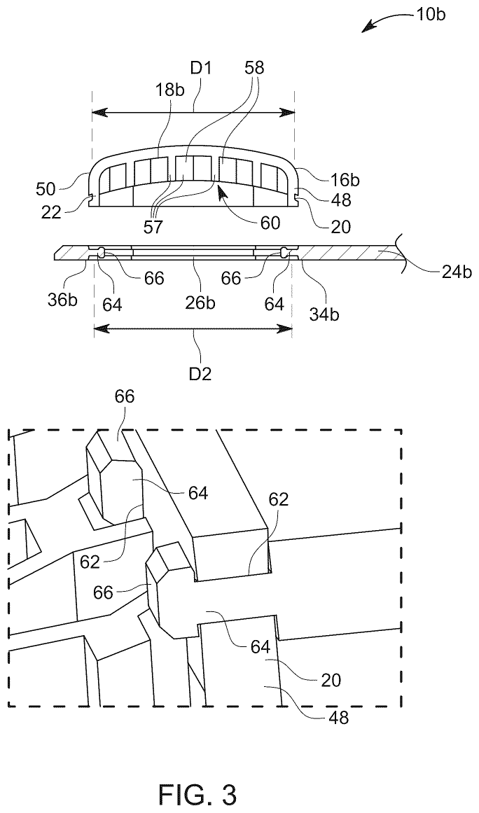

FIGS. 3-4 and 6 illustrate a second embodiment, again for a wrist rest device 10b that incorporates a mouse pad 30. However, it may also be made of a larger size for use with a keyboard 14, as mentioned above. The wrist rest device 10b is of the same overall design as the one in FIG. 2, with the differences being the wrist support 16b interior and the manner of securing the wrist support 16b in the receiving space 26b.

In the wrist support interior space 46b, a plurality of vertical members or walls that extend downwardly from the upper wall 18b, preferably integrally molded therewith. In this non-limiting embodiment, the vertical members are vertical walls 57 creating an arrangement of adjacent hollow cells 58. The illustrated cells have a hexagonal shape with adjacent cells 58 sharing a common wall to create an open “honeycomb” structure 60. Other open columnar cell structures arranged in the generally vertical direction may be used, including other polygonal cross-sections, such as square, triangular, quadrilateral, pentagonal, etc., or rounded cross-sections, such as circular, ovular, elliptical, etc. Thus, the honeycomb configuration is not limiting. Techniques for forming columnar cells in other fields, such as for mattresses are known, such as in, e.g., U.S. Pat. Nos. 7,827,636, 7,823,233, and 8,607,387, the entirety of each of which is incorporated herein.

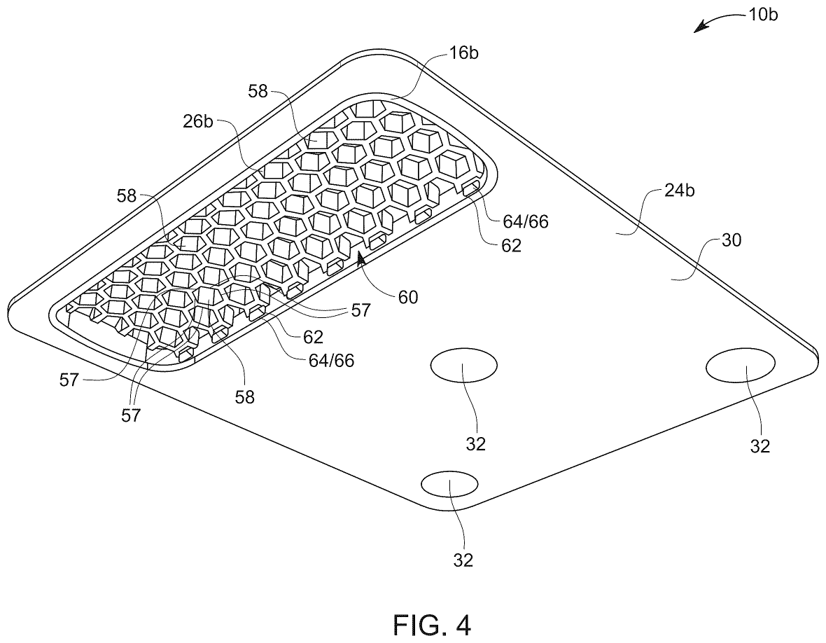

As illustrated, the honeycomb structure 60 extends between the forward and rearward walls 48, 50 with the cell walls adjacent thereto connected to those walls. The honeycomb structure 60 may also extend between the lateral walls 52, 54 with the cell walls adjacent thereto also connected to those walls 52, 54. In this embodiment, the walls forming the cells 58 do not extend all the way to the bottom plane of the wrist support 16b. Instead, they are spaced upwardly therefrom, as can be appreciated best from FIGS. 3 and 4. That is, the plurality of vertical members extend downwardly from the upper wall such that when the upper wall is undeflected (i.e., relaxed with the user not leaning on it) the vertical members 52, 52 are spaced upwardly from a bottom plane of the wrist support so as to be spaced above the work surface. As shown in FIGS. 3 and 4, the walls are of generally the same vertical length, but because they extend down from a curved or arched upper wall 18b their bottom edges also follow a similar curved or arched shape in terms of relative positioning. As a non-limiting example, the bottom edges can be arranged with a curvature or arch that is circumscribed or approximately by the shape of an imaginary ellipsoid, sphere or other shape that has curvatures or an arch shape in both the lateral and front-back directions, or a cylinder or other shape that only has curvature or arching in the front-back direction. This is not limiting, and it is also possible to design them so that they extend such that their bottom edges share a common horizontal plane.

The vertical members or walls 57 creating the cells 58 provide additional support for the upper wall 18 against excessive downward deflection. In particular, the vertical nature provides some support against such deflection. The connection to the wrist support outer walls may also help constrain the cells 58 against horizontal deflection and/or the cells 58 may conversely help support against outward deflection of the wrist support walls. For example, viewing a cross-section in a lateral direction like FIG. 3, it can be appreciated that as the middle of the upper wall 18 is pushed down, the cells 58 will become compressed more in the front-back direction between the front/rear walls of the support 16 because the curvature of the bottom edges of the cell walls 57 (which also may be referred to as the bottom of the honeycomb or other columnar cell structure) is becoming flatter. As an example, FIG. 6 shows side-by-side examples of two wrist supports 16b′, 16b″ with different curvatures imparted to the bottom of the honeycomb/columnar cell structure. The left one has a more shallower curvature, whereas the right one has a deeper curvature.

Depending on the level of upper wall deflection desired, a variety of factors can be modified to achieve this, including the material selection, the thickness of the wrist support outer walls, the thickness of the cell walls 57, the size and number of the cells 58, the shape of the cells 58, the curvature (if any) imparted to the bottom of the honeycomb/columnar cell structure, and the front-back, lateral or height dimensions of the wrist support 16b. Thus, the illustrated design is not intended to be limiting and the desired characteristics of the wrist support 16b can be achieved through a wide range of variations.

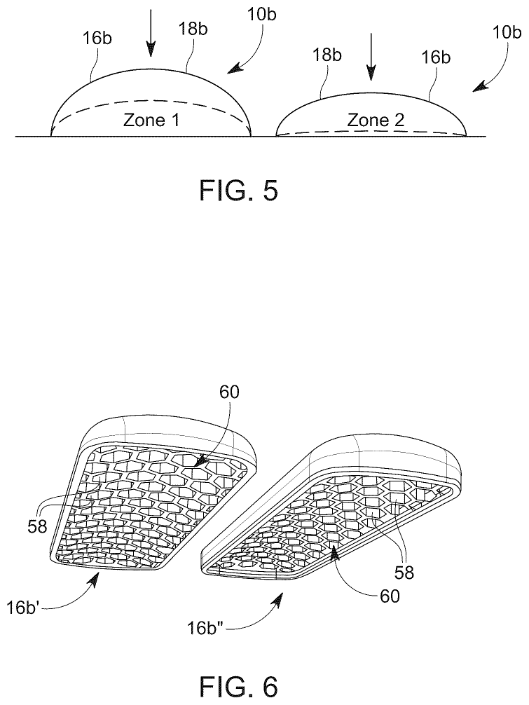

As shown in FIG. 5, one non-limiting advantage of the columnar structure not extending all the way to the bottom plane in the illustrated embodiment is that two vertical “zones” of deformability for wrist support can be achieved. That is, they do not extend to the bottom plane provided by the wall edge portions which contact the work surface during use. The left image of FIG. 5 schematically represents a relatively light loading (Zone 1), whereas the right image represents a heavier loading (Zone 2). Because of the structure within the wrist support 16b, as the upper wall 18b is pushed further down (i.e., as the loading increases), the upward resistance or biasing force increases in more non-linear manner because the cell walls 57 become more subject to stress and thus provide a more additive amount of resistance upwardly to the upper wall 18b. This helps keep heavier wrist loading, such as from a larger person or a person that more aggressively leans on the wrist support 16, from excessively deflecting the upper wall 18b.

Additionally, FIG. 3 shows the manner in which the wrist support 16b is connected to the frame 24b in the device 10b. FIG. 3 shows the wrist support 16b as having has a plurality of spaced apart retainer openings 62 formed along the forward wall 48 thereof on the edge portion 20 thereof. The same openings 62 are formed along the rear wall 50 on its edge portion 22. In the illustrated embodiment, the openings 62 are through openings, although in other embodiments they do not need to go all the way through the wall thickness. The frame 24b has retainer projections 64 arranged along the forward and rearward edges 34b, 36b of the wrist support receiving space 26b. The retainer projections 64 are spaced apart in the same manner as the openings 62. When the wrist support 16b is inserted into the space 26b, the forward and rearward walls 48, 50 can be flexed inward to clear the projections 64 and the openings 62 and projections 64 are aligned so that the projections 64 can be inserted into the openings 62. This results in the wrist support 16 being firmly secured to the frame 24b, as shown in FIG. 4.

The illustrated design also includes heads 66 on the projections 64, which heads 66 are oversized with respect to the openings 62. The deformable material allows the heads 66 to compress to fit through the openings 62 and then resiliently return to their original shape to resist withdrawal of the projections 64 from the openings 62. The heads 62 may in some embodiments be designed to be compressed for withdrawal also so the device can be disassembled. The use of the heads 66 is also optional and should not be considered limiting.

Other approaches for securement of the wrist support 16b to the frame 24b may be used. For example, other retainers can be used, such as detent engagements, snap-fit features, latches, adhesive, etc. may be used. As another example, the wrist support 16b could have a groove about its periphery on the walls and the edge of the wrist receiving space 26b could be received in that groove for securement of the wrist support 16b.

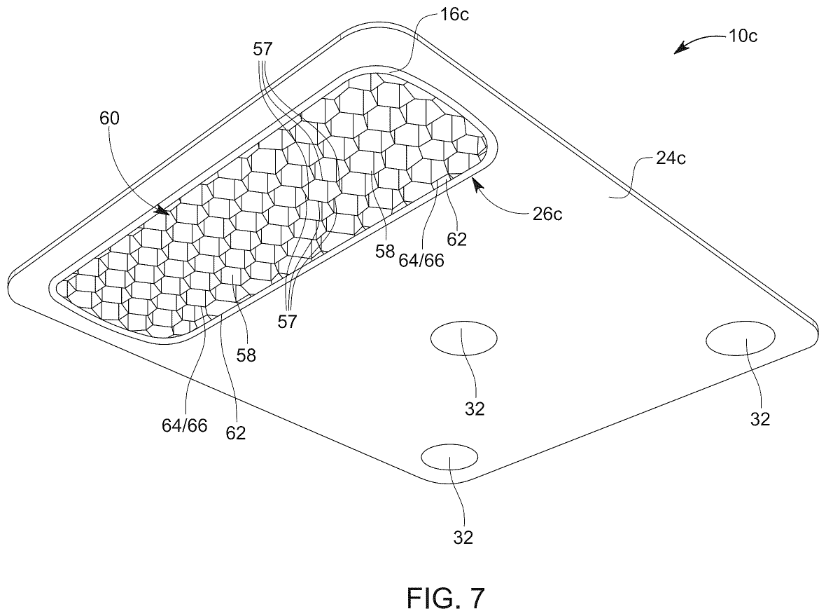

FIG. 7 shows another embodiment 10c similar to that of FIGS. 3-4 and 6, with the exception that the walls 57 of the columnar cells 58 (e.g., shown as forming the honeycomb structure 60) extend to the bottom plane of the wrist support 16c. Thus, when the wrist support 16c is on a work surface like the frame 24c, such as a desk surface, the bottom edges of the cell walls 57 may engage the work surface. This construction may have the benefit of providing more resistance to deflection, as the cell walls 57 are compressed between the wrist support 16c upper wall and the work surface by the weight of the user's wrist/hand.

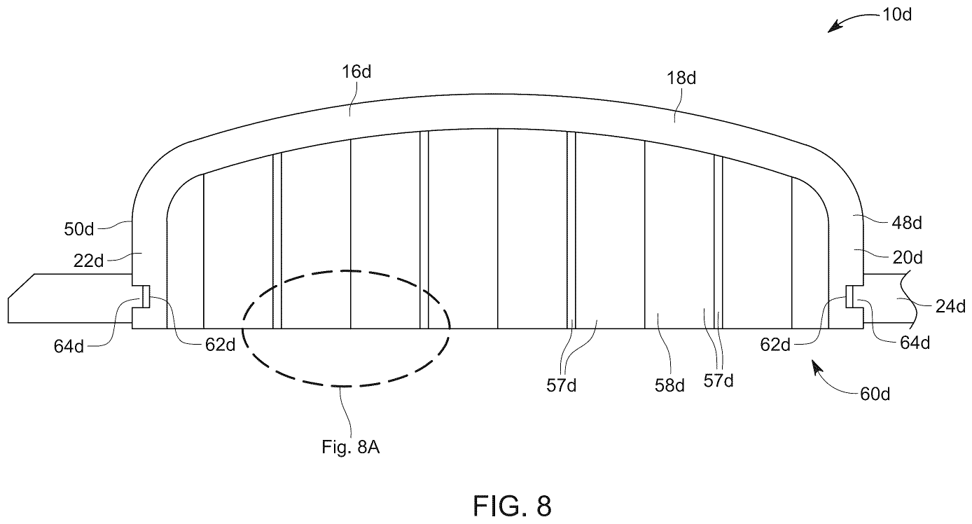

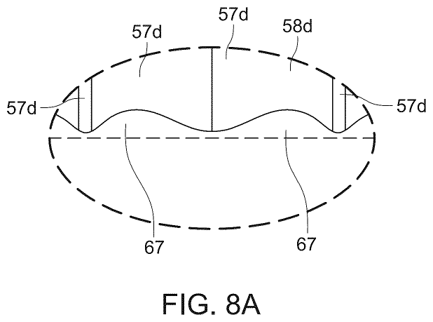

FIG. 8 shows a modification 10d of the design in FIG. 7 where the cell walls 57d are gradually tapered from a thicker upper portion connected to the upper wall 18d towards a thinner lower portion. The thinner lower portion has the bottom edges that engage the work surface. This wrist rest device 10d has the benefit of providing a more controlled or gradual increase in resistance to downward deflection of the wrist support 16d upper wall 18d. In particular, as the upper wall 18 is pressed down by the user's wrist/hand, the initial deflection of the cells manifests as bending in the thinner lower portions. However, as more downward pressure is applied, the bending focus gradually rises such that the bending occurs at higher points on the cell walls 57d, which are increasingly thicker due to the tapered configuration. Thus, the bending resistance increases in the cell walls 57d, which increases the resistance to downward deflection of the upper wall 18d. This approach can create a behavior similar to the Zones 1 and 2 discussed above provided in the more curved designs with the tapered configuration of the cell walls 57d contributing to that effect.

FIG. 8 also provides non-limiting examples of dimensions for various components, such as 3 mm thickness for the wrist support walls 18d, 48d, 50d, 52d, and 54d, 12 mm for the width of the walls 57d forming the hexagonal cells 58d, and 0.5 mm for the thickness of the walls 57d at their junction with the upper wall 18d (with the thickness tapering therefrom towards the bottom). These dimensions are not limiting and are provided as just one example for context.

FIG. 8 also provides an example showing the retainer openings 62d formed along the forward and rearward walls 48d thereof at adjacent the edge portion 20d thereof where the retainer openings 62d do not extend all the way through the walls 48, 50. The retainer projections 64d are designed without the heads 66. With this approach the resilient deflection of the walls 48d, 50d away from one another during installation of the support 16d into the frame 24d is sufficient to maintain engagement of the openings 62d with the retainer projections 64d. Again, this is also a non-limiting approach.

FIG. 8A shows a modification of the FIG. 8 embodiment, although it can be applied to the FIG. 7 embodiment of any other embodiment, particularly where the walls 57d of the columnar cells 58d (e.g., shown as forming the honeycomb structure 60) extend to the bottom plane of the wrist support 16d where it contacts the work surface (included in dashed line in FIG. 8A for reference). One or more walls 57d of each cell 58d are provided with an air passage 67 to permit air to escape from the cell interior as the wrist support 16d is compressed downward and/or enter the cell interior as the wrist support rebounds upwardly. Specifically, on downward compression, because the cell walls 57d reach the bottom plane of the support (and hence the work surface on which it rests) air entrapped in the cells 57d can become pressurized and may make noise as it escapes underneath the cell wall bottom edges (absent some controlled passage for permitting air to escape like air passages 67). Conversely, on upward return to its original shape, the cell wall 57d bottom edges pressed against the work surface may also block air from entering one or more cells 58d, creating negative pressure resistance and/or suction noise when the pressure differential is sufficient for forced air entry under the edges. As illustrated, the air passage 67 is an upwardly extending recess on the cell wall 57d bottom edges, which permits the air the flow into and/or out of the cell interiors without having to be forced under the engaged bottom edges. However, the air passage 67 can have any configuration, including a notch, slot, hole, series of holes communicating through the cell walls 57d and through the wrist support outer walls. The air passages may also be provided on the cell walls by being formed as notches or recesses between cell walls. That is, at the point where two cell walls meet, a notch or recess may be formed in one or both adjacent walls so the air can escape between the two adjacent cell walls. Thus, the illustrated embodiment is not limiting.

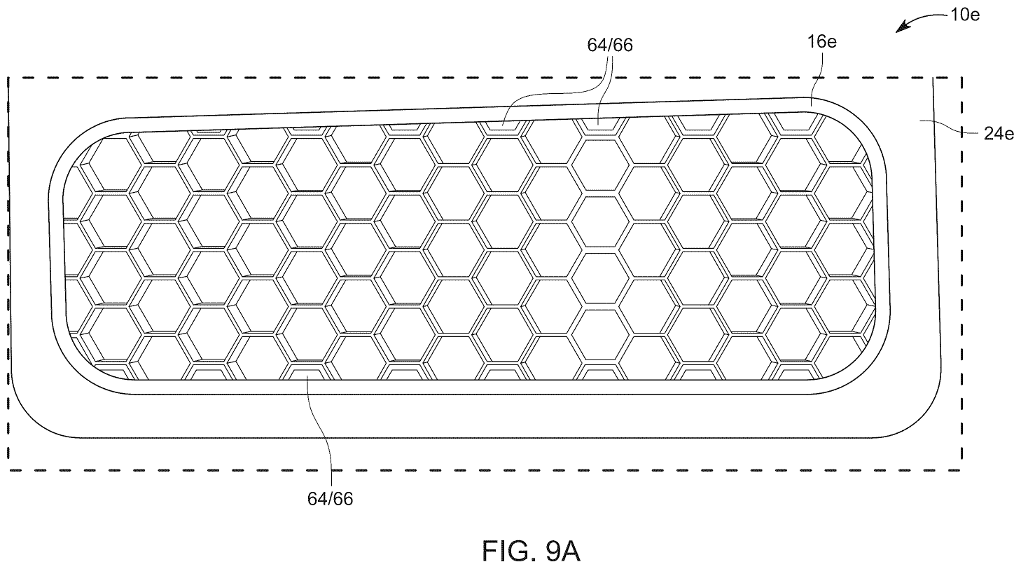

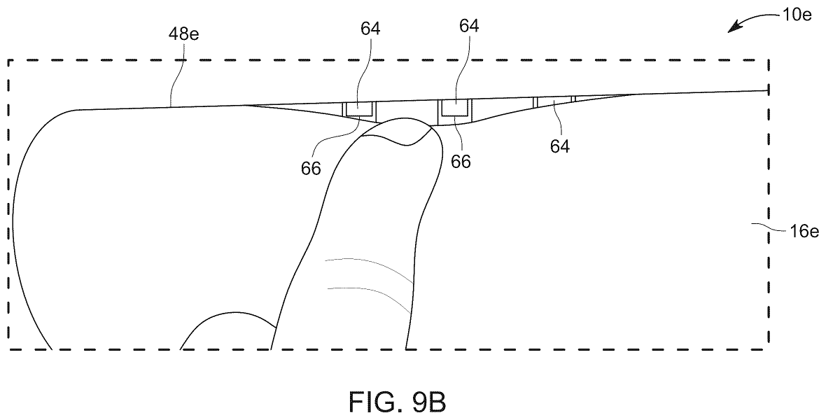

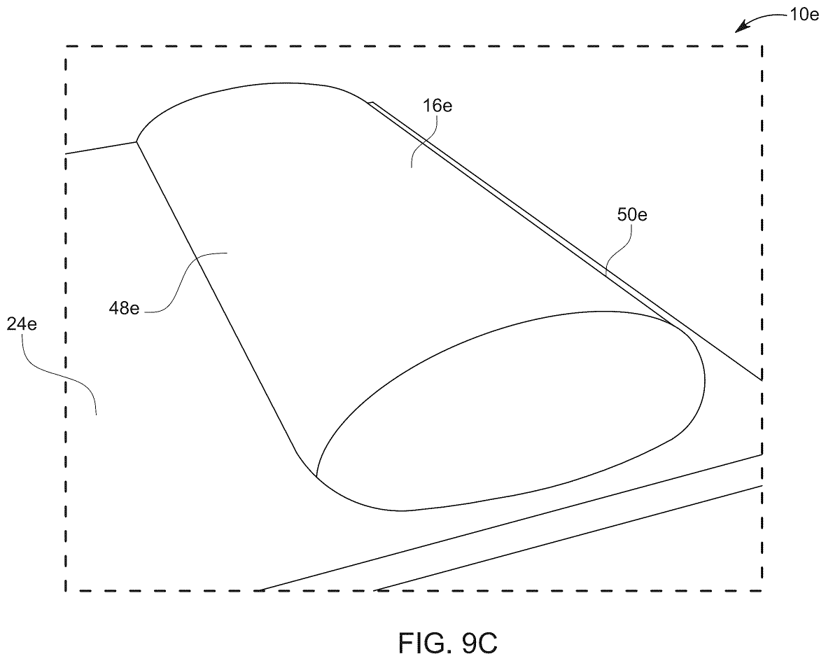

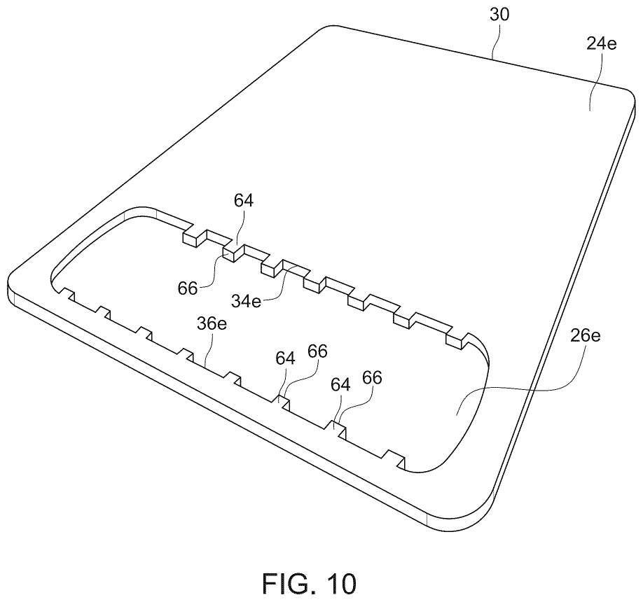

FIGS. 9A-C show an embodiment of a wrist rest device 10e similar to FIG. 7, and using the retainer openings 62 that extend through the forward and rearward walls 48c, 50e with retainer projections 64 that have the optional heads 66. For convenience, the common reference numbers from FIG. 7 and other embodiments are used for specific components. FIG. 9B shows how a wall 48c (or 50c) of the wrist support 16e can be deflected inwardly for receipt of the retainer projections 64 into the openings 62 (or conversely for withdrawal during removal). FIG. 9C shows how the design has a visually appealing look with the wrist support 16e securely, but removably, connected to the frame 24c. FIG. 10 shows the frame 24 used in FIGS. 9A-C in isolation, i.e., separated from the wrist support 16e, for convenience and clarity.

In any of these columnar cell embodiments, the cells may terminate above the support surface and the cell walls may have ribs extending down therefrom, which ribs are not connected to one another. These ribs can provide some initial resistance to deflection, albeit at a low level, and then as the wrist support is deflected downwardly further compression of the columnar cells may occur. These ribs may be continuous with one or more of the walls of each cell, including all the walls. They may have the same thickness as the cell walls, or may be tapered. They may be formed in the same molding process, or they may be cut slightly upwardly from the cell walls to create the ribs separated from one another post-molding.

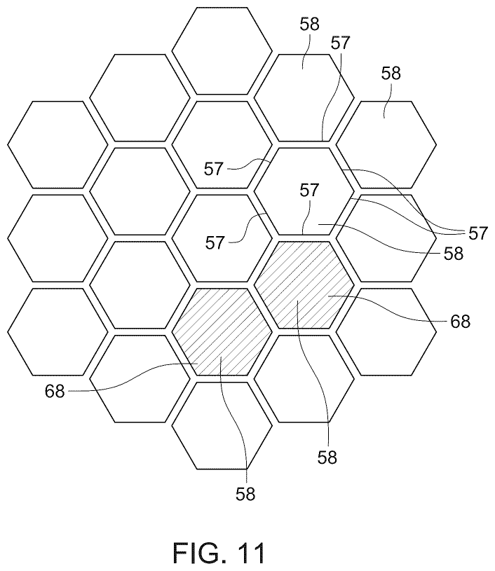

FIG. 11 illustrates an optional concept where a filler material 68 is included within the cells 58. While the honeycomb structure 60 is illustrated, the filler material 68 may be used with any shape columnar cell structure, and it may also be used in other designs where cells are not used and the is open space between support walls, ribs or other structures in the interior of the wrist support 16 (such as additional embodiments discussed below). The filler material 48 is typically injection molded or overmolded into the cells 58, or may be introduced into those cells by a controlled pouring method or other approach. The filler material 68 is designed to provide additional resilient support to the wrist support 16 by adding further material to resiliently resist downward deflection of the wrist support 16 upper wall 18. The filler material 68 may also provide such resilient support by providing resistance to bending of the cell walls 57 as the cells 58 are compressed downwardly. The filler material 68 preferably has a lower hardness than the material forming the walls 57 (and the rest of the wrist support 16, which is illustrated as being formed as one-continuous piece). For example, the filler material 68 may be TPE blend, TPE, and polyurethane foam. The filler material 68 may have optionally differing durometer and properties than the molded wrist rest to add supplemental support when and where desired. The filler material 68 may have a hardness in the range of 40-65 Shore A, with a preferred range of 40-45.

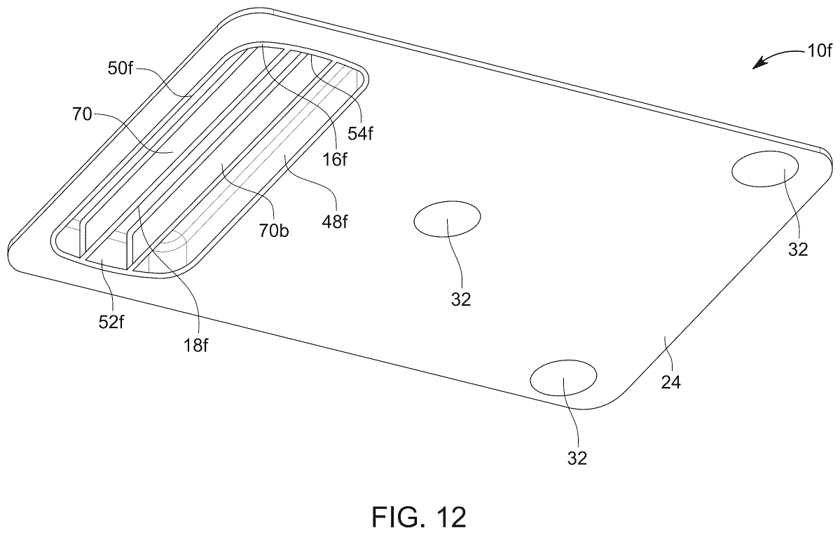

FIG. 12 illustrates an embodiment of a wrist rest device 10f with an internal support structure that is not arranged in a columnar cell configuration. Specifically, FIG. 12 has one or more, and in the non-limiting example two, parallel walls 70 within the wrist support 16f interior that extend parallel to the forward and rearward walls 48f, 50f. The walls 70 are connected to the inner surface of the upper wall 18f, and may also be optionally connected at the longitudinal ends to the end walls 52f, 54f for additional support against deflection. As the weight of the user's wrist/hand presses down on the upper wall 18f, these walls 70 will deflect to provide resilient support against the downward deflection of the upper wall 18f. Substantial downward movement of the upper wall 18f may induce bending of these walls 70, particularly in the central region thereof, and thus increased resilient reaction force may be created not just due to the downward compression of the walls 70, but also by their deflection in a bending manner. This design is not limited to two walls, and other numbers of walls may be used.

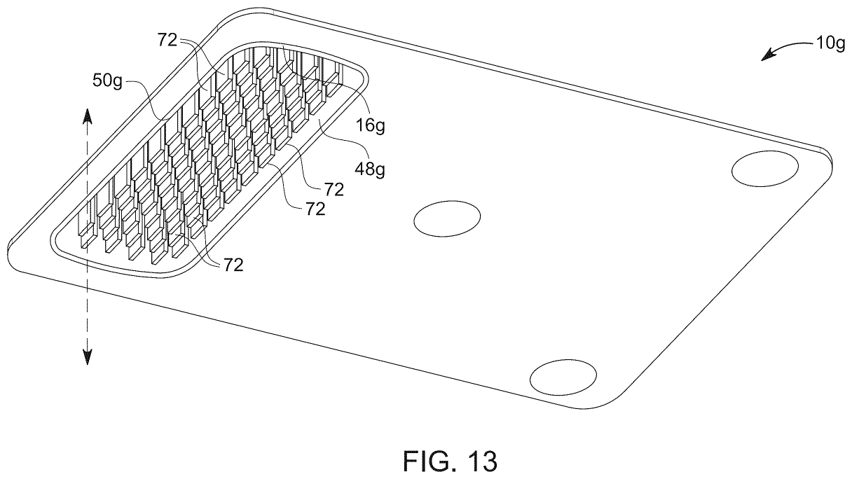

FIG. 13 illustrates another embodiment of a wrist rest device 10g with another internal support structure using a plurality of short walls or ribs 72 extending downwardly from the upper wall 18 (not seen). These ribs 72 may extend to the bottom plane of the wrist support 16g so as to contact the work surface on which it rests. As the weight of the user's wrist/hand presses down on the upper wall 18, these ribs, which may be in the form of short walls 72, will deflect to provide resilient support against the downward deflection of the upper wall 18. By “short” walls, this refers to the walls being relatively narrow in their width direction as compared to the vertical direction. In the non-limiting embodiment illustrated, the ribs 72 are arranged in rows parallel to the forward and rearward walls 48g, 50g. Further, the ribs 72 are arranged such that each adjacent pair of rows has the ribs 72 staggered or offset with respect to the other in the direction parallel to those walls 48g, 50g. As can be seen, the ribs 72 of all the rows are generally aligned in diagonal directions (an example of which is shown with a dashed line). The staggered approach has the advantage of increasing the probability that edges of adjacent ribs 72 from adjacent rows may contact one another if twisting deformation is induced, which help limit the deflection and provide additional resistance. However, this arrangement is not limiting and any arrangement may be used. Likewise, the ribs may have different shapes, including cylindrical or ovoid in cross-section, and need not have a planar shape like the short walls.

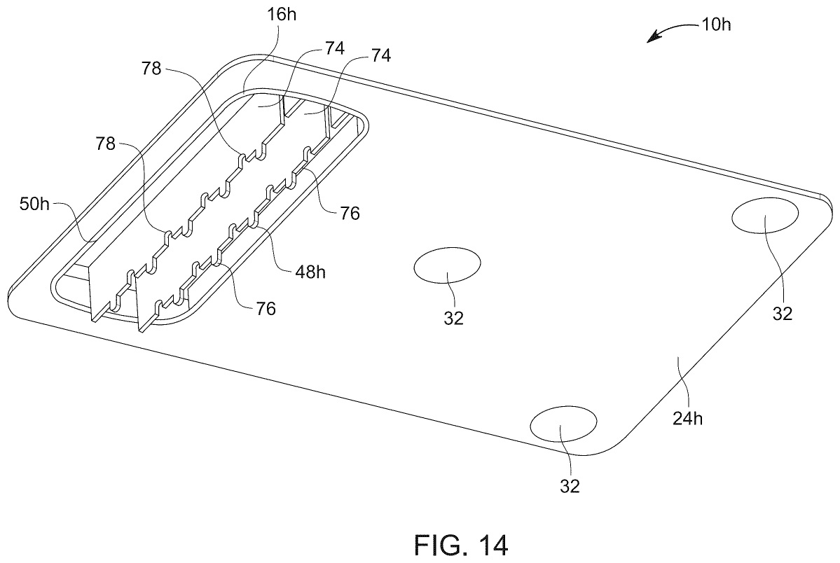

FIG. 14 illustrates a wrist rest device 10h that is modification of FIG. 12. Specifically, in FIG. 14 a pair of walls 74 (or any other number) are arranged in the same manner as FIG. 12, except the walls 74 extend below the bottom plane of the wrist support 16h. Thus, when the wrist support 16h is placed on a work surface, the walls 74 will be pretensioned under bending stress. This provides additional resilient support for the upper wall 18 (not seen). As a non-limiting feature, the ends of the walls 74 may be provided with projections 76 and recess 78. For each pair of adjacent walls 74, the projections 76 on one wall 74 are aligned in longitudinal direction with the recesses 78 on the other wall 74. If the walls deflect towards one another as the upper wall 18 is pressed down by the user's wrist/hand, the projections 76 and notches 78 can engage with one another and inhibit the walls 74 from sliding over one another. This has the advantages of providing increased resilient support as each wall 74 provides mechanical support tending to resist bending of the other. The walls 74 may be angled towards one another to promote this behavior.

In any of these designs with walls, ribs, etc. used as the internal support structure, those components may alternatively be changed in orientation by 90 degrees so as the extend between the forward and rearward walls 48h, 50h, rather than parallel to them. Thus, the illustrated designs shown are not intended to be limiting.

FIG. 15 illustrates yet another embodiment of a wrist rest device 10i. The device 10i includes a frame 24i. The frame 24i includes a bottom peripheral frame member 80 with a pad receiving opening 82. A mouse pad 30i formed of a harder material like the others discussed above. The frame 24i also includes an upper peripheral frame member 84, which connects securely to the bottom frame member 80 in a manner to be discussed. The frame 24i also includes a wrist support 16i, which may be made in any manner, including in accordance with any of the embodiments discussed herein. The frame 24i also includes a flexible covering sheet or membrane 86, which may be of any flexible material, including textile, stretchable material, such as Elastane, Spandex, Nylon, Lycra and for more sustainable alternatives, Sorona (made from 37% corn) and INVISTA a bio-based Lycra fiber (Spandex and similar materials are being reutilized by a company called Spanflex. The Global Organic Textile Standard allows for garments to have 5% Spandex within the textile while still remaining organic, if an organic material is selected. The sheet 86 has a wrist support receiving portion 88 that provides the wrist support receiving space 26i, which in the illustrated embodiment is shaped to conform to the external shape of the wrist support 16i. Specifically, the wrist support receiving portion 88 extends upwardly from the sheet 86 and is integral therewith, and opens concave downwardly to receive the wrist support 16i.

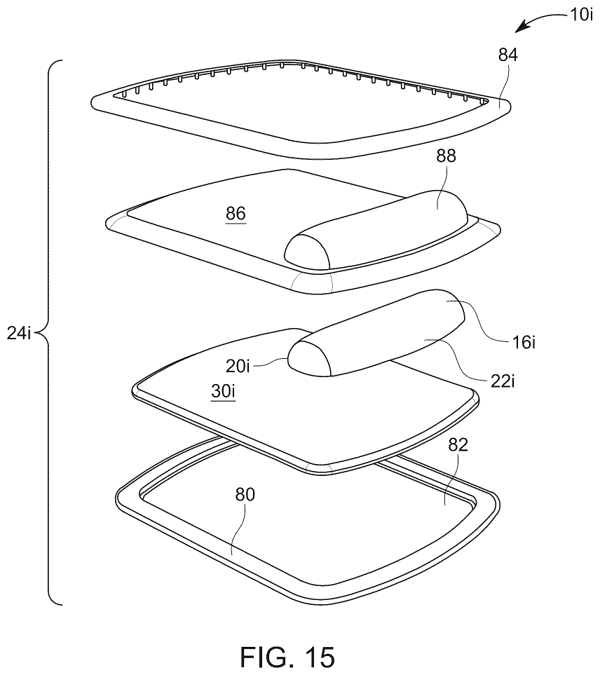

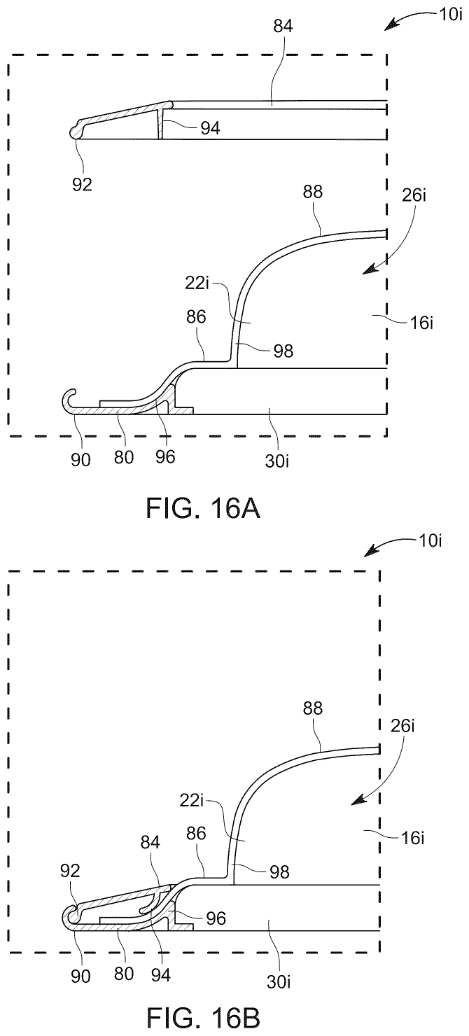

As shown in FIG. 16, when assembled (as discussed with reference to FIG. 16), the wrist support 16i is placed on the device support pad 30i and the sheet 86 is placed over the pad 30i with the wrist support 16i received in the wrist support receiving space 26i of the receiving portion 88. The pad 30i is received in the space 82 in the bottom frame member 80 and the upper frame member 84 is secured to the lower frame member 80. The upper and lower frame members 80, 84 have cooperating interlocking structures 90, 92 to removably secure the upper and lower frame members 80, 84 together. Other types of interlocking structures may be used, including other snap-fits, interlocking teeth, detents, interference interlocking features, or any other structure for securing the upper and lower frame members together. The upper frame member 84 also has a sheet engaging member 94 or a plurality of them arranged around its periphery inwardly adjacent the interlocking structure 92 to engage the peripheral edge portion of the sheet 86 against the lower frame member 80 to hold the sheet 86 in place over the pad 30i and wrist support 16i. The lower portion 84 also has a raised, curved region 96 (curving to face concave upwardly) arranged around its periphery inwardly adjacent the interlocking structure 90 and over which the sheet 86 is pulled and against which the sheet engaging member 94 presses the sheet 86 to provide an increased frictional securement. As illustrated, the sheet engaging member 94 is resiliently deformable so its resiliency provides a reaction force to help secure the edge of the sheet 86, and its curving also increases the surface area engagement with the sheet edge for enhanced frictional retention. Other techniques for securing the sheet 86 may be used, including reversal of the components identified, use of further undulating surfaces to increase frictional engagement, pin and holes to firmly lock the sheet edge, clamps, clasps, fasteners, or any other types of securement.

In this non-limiting embodiment, the wrist receiving space 26i for receiving and removably securing the wrist support 16i to the frame 24i is provided by the sheet 86, and particularly the wrist support receiving portion 88 thereof. The sheet 86, which is part of the frame 24i, thus engages at least the forward and rearward edge portions 20i, 22i of the wrist support 16i to prevent deflection of the edges away from one another. This is due to the sheet 86 having the bottom forward and rearward edges 98 (only the rearward being seen) of the receiving portion 88 engaged with the forward and rearward edge portions 20i, 22i. That is, this engagement causes the sheet 86 part of the frame 24i to resist deflection of the forward and rearward edge portion 20i, 22i away from one another under the weight of the user's hand/wrist resting on the wrist support 16i. This embodiment is not limiting, and also confirms that the present application includes embodiments where the frame engages at least the forward and rearward edge portions of the wrist support to prevent deflection of the edge portions away from one another via structures besides just the more rigid part of the frame.

The sheet 86 may also be made of a thicker material such that the wrist rest support receiving support 88 is self-supporting, i.e., it retains its general shape corresponding to the wrist rest 16i under no load prior to being installed. This may be done with a thicker material, such as one that provides additional cushioning comfort. The sheet 86 may also be flaccid.

FIG. 17 illustrates another embodiment of a wrist rest device 10j, which is designed as a standalone wrist rest-meaning it has no device supporting pad 30. In FIG. 17, the frame 24j consists essentially of a frame member 102 formed in a closed-loop or annular configuration of a harder material than the wrist support 16 material, as discussed previously above. The wrist support 16j may have any construction or configuration, including in accordance with any of the embodiments discussed herein. The wrist support 16j has a frame receiving slot 104 extending around the periphery thereof. The slot 104 preferably has a shape that is complementary to the frame member 102 to receive the frame member 102 therein. The frame member 102 can be snapped over the wrist support 16j and the engagement of the frame member 102 with the slot 104 provides additional rigidity and support to the wrist support 16, similarly to how the edges of space 26 in the device receiving pads 30 above support the wrist support 16. Specifically, the frame member 102 provides a wrist support receiving space 106 in which the wrist support 16j is received and removably secured; and the frame 24j/frame member 102 engages at least the forward and rearward edge portions 20j, 22j of the wrist support 16 to prevent deflection of the edges away from one another. This embodiment thus avoids the extra component of the device receiving pad and provides a standalone wrist rest device 10j.

Other configurations for the frame member 102 may be used, such a partially closed-loop that has a gap between spaced ends or a pair of separate U-shaped frame members that fit over the wrist support 16j within the slot 104 to perform the same function. Also, the wrist support 16i and the frame member 102 may have openings and retainer members like the embodiments previously described. Thus, the illustrated embodiment is not limiting.

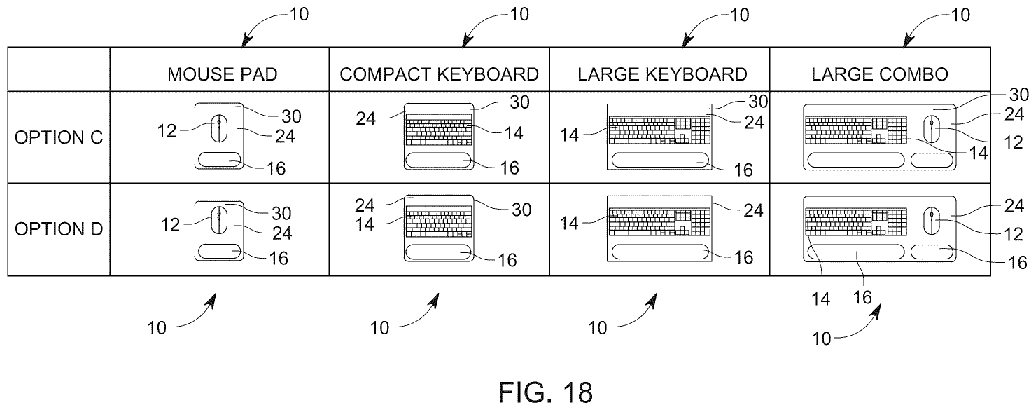

FIG. 18 shows a variety of different implementations for the wrist rest device (all of which are generally denoted as 10), which may use any of the approaches discussed herein or any other embodiments. Starting from the left, the first ones shown are where the wrist rest device is implemented on a mouse pad, where the frame 24 provides a device support pad 30 in the form of a planar mouse pad for receiving a mouse 12. The second and third ones shown are where the wrist rest device 10 is implemented on keyboard supports, the second ones being more compact and the third ones being larger with a numerical key section included to the right side. In these embodiments, the frame 24 provides a device support pad 30 in the form of a planar keyboard support for receiving a keyboard 14. The fourth or rightmost ones shown is where the wrist rest device are implemented on a combined keyboard/mouse pad unit, where the frame 24 provides a device support pad 30 a portion of which provides a planar mouse pad for receiving the mouse 12 and another portion of which provides the planar keyboard support for receiving the keyboard 14. In this embodiment, the frame 24 may have two wrist support receiving spaces 26 and two corresponding wrist supports 16, the smaller of which is for supporting the user's wrist/hand when using the mouse 12 on the mouse pad portion of the frame 24 and the larger of which is for supporting the user's wrist/hand when using the keyboard 14 on the keyboard portion of the frame 24. A right-hand version is shown and a left-hand version may also be provided with the mouse pad and associated wrist support on the left side. The dimensions and configurations of these examples are not intended to be limiting, and FIG. 18 is provided to illustrate the wide range of devices to which any embodiment of a wrist rest device of the present application may be applied.

Various of the features herein can be practiced independently. For example, a stand-alone wrist rest can be made without any frame (and thus does not need openings to received projections from the frame), but may have one or more of the other features discussed herein (e.g., cell structures, the air passages, the various internal walls or ribs, etc., tapered internal walls, an internal support structure with an arched bottom, etc.). Any variety of the features in the various embodiments may be practiced together or individually in different variations of wrist rests.

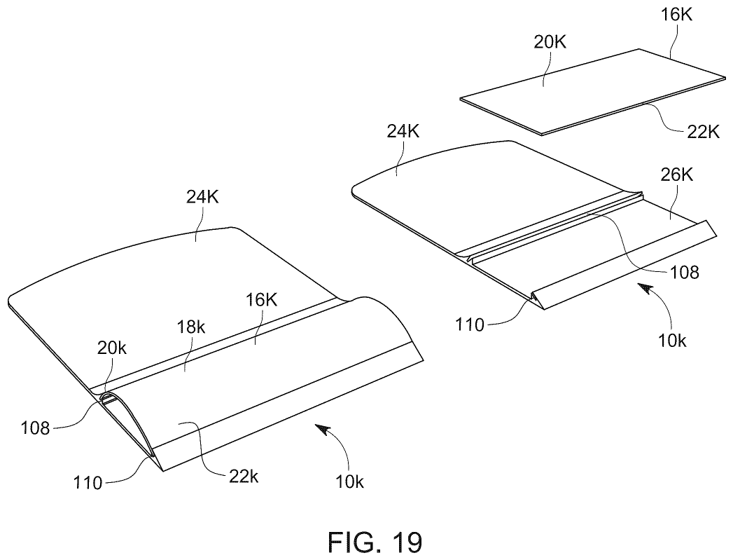

FIG. 19 illustrates yet another embodiment of a wrist rest device 10k. The general principles are similar to the other embodiments, except in this embodiment the wrist support 16k made from a harder, but still deformable material, that can be bent into and maintain a bowed configuration as shown. The wrist support 16k material will be harder and more rigid because, rather than being thicker and relying on the material being of the cushioning type for supporting the user's wrist/hand, the material is in the form of a sheet and the resiliency is derived more from its geometric configuration, including the extent of its bowing and the bending resistance of the material due to its Young's modulus. Thus, the material is still deformable because of its sheet construction but resiliently returns to its original substantially flat shape when unstressed (as in the case when the device is disassembled). Likewise, when assembled the material of the wrist support 16k will resiliently return to its pre-tensioned bowed configuration after the weight of user's wrist/hand is removed during usage. The sheet thickness may be in the range of 0.010-0.060 inches, preferably in the range of 0.020-0.050 inches, and more preferably in the range of 0.025-0.040 inches. Materials that may be used include recycled polypropylene, reinforced pressboard, vinyl, PVC, synthetic and natural felt, leather, thin wood veneer including bamboo, etc.

The sheet forming the wrist support 16k may optionally be coated or have padding material on the upper surface there to improve comfort.

The sheet forming the wrist support 16k has an upper wall 18k, which is the upper section in the middle region of the bowed installation position. The sheet also has forward and rearward edge portions 20k, 22k extending in the lateral direction. The frame 24k has a device receiving support pad 30k, shown as a mouse pad. The frame 24k also has a pair of laterally extending forward and rearward slots 108, 110 on opposing sides of a wrist support receiving space 26k for receiving and removably securing the wrist support 16k to the frame 24k. As shown, the wrist support 16k is installed by bowing it and inserting the forward and rearward edge portions 20k, 22k into the laterally extending forward and rearward slots 108, 110, thus imparting the bowed configuration. Thus, the frame 24k engages the forward and rearward edge portions 20k, 22k of the wrist support 16k to prevent deflection of the edge portions 20k, 22k away from one another. This maintains the bowed configuration and the wrist support 16k is pre-tensioned so as to support the user's wrist/arm during use in a resilient manner. Instead of slots, the retention may be provided by ledges, detents, snap-fitting, or other retention structures. Because the edges of the wrist support can be disengaged, thus removing the pre-tensioning so the wrist support 16k can assume a substantially flatter configuration, this approach can be regarded as a collapsible wrist rest device also, as the parts themselves can be collapsed to take up less space, which may be desirable for storage or placement in a laptop bag, etc.

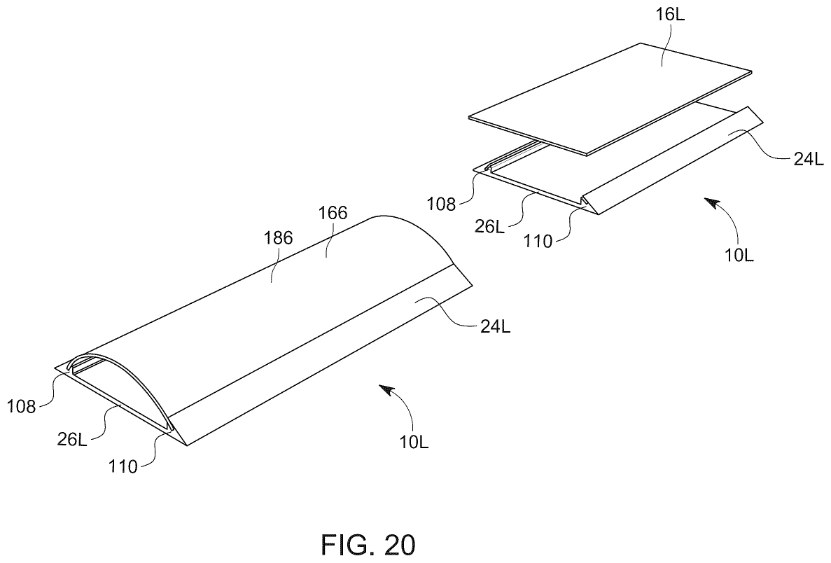

FIG. 20 shows a wrist rest device 10l similar to FIG. 19, except it is designed as a stand-alone wrist rest device (as was the case for FIG. 17). The principles of the design in FIG. 20 are the same as FIG. 19, except the device support pad is omitted.

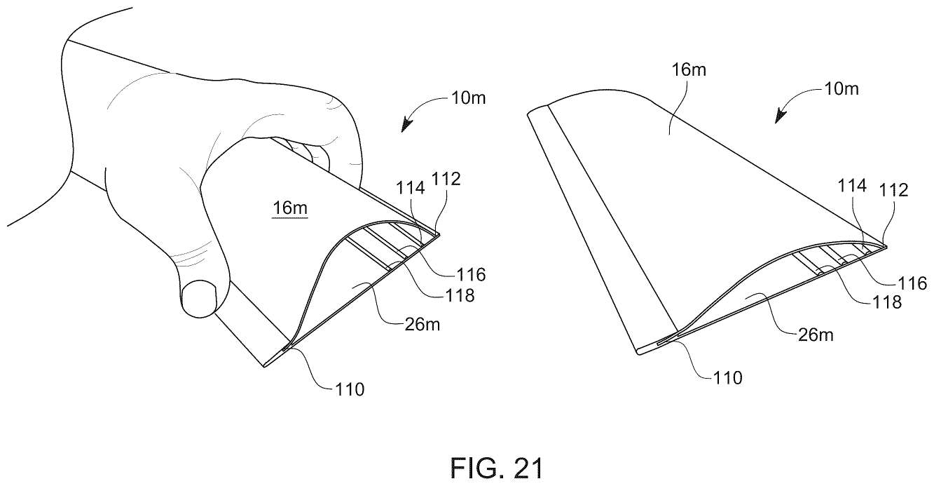

FIG. 21 shows a wrist rest device 10m similar to FIGS. 19 and 20, which may follow either approach (i.e., be standalone or have a device support pad). In the design of FIG. 21, the additional feature is that a series of retention mechanisms for an edge portion of the sheet wrist support 16m are arranged in the front-back direction, as shown at 112, 114, 116, 118. The same retention mechanisms discussed above may be used as mentioned above for FIG. 19, and the illustrated embodiment has them arranged at the front (although they can be at the rear also). As illustrated, the slots are created by laterally extending ribs that are angled to provide the slots. However, because they are arranged in the front-back direction, the extent of the bowing of the sheet wrist support 16 can be managed by inserting the edge portion of the sheet into different slots (or whatever retention mechanism is used). For example, in FIG. 21 the edge portion 20m is inserted into the forwardmost slot 112, which provides the least amount of bowing. When the edge portion 20m is inserted into each progressively rearward slot, the edge portions will be closer to one another and the bowing is increased (and likewise the amount of resilient resistance for supporting the user's wrist/hand is increased). Thus, the user can choose his/her desired level of resistance based on the engagement selected.

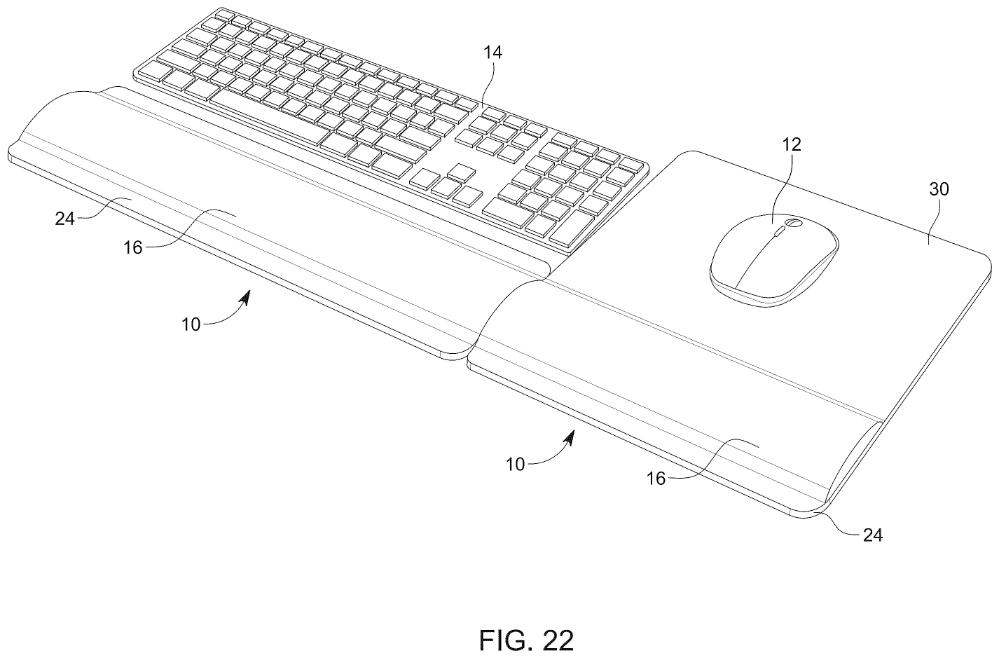

FIGS. 22-24 illustrates two wrist rest devices, one with a pad 30 for supporting a mouse 12 and the other having no pad 30 and being longer for use with the keyboard 14. The generic reference numbers 10 etc. will be used for this discussion for convenience, and although wrist rest devices like those in FIGS. 19-21 are shown, the approach in FIGS. 22-24 can be used with any wrist rest approach discussed herein. In FIGS. 22-24 the keyboard and mouse wrist rests are secured together by interlocking structures, which may be in the form of latches, fasteners, retainers, snap-fit features, detents, etc.

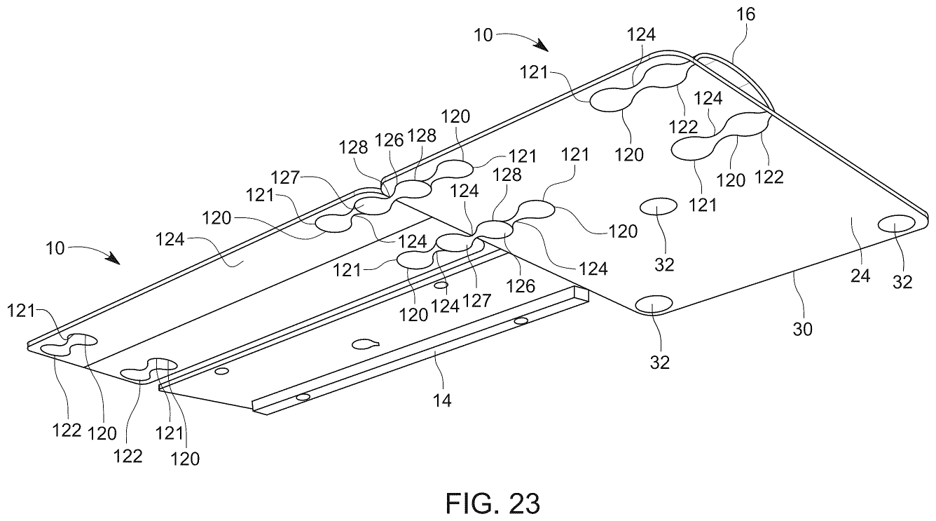

FIG. 23 shows an embodiment for securing two wrist rest devices together (or one wrist rest 10 and another device that supports an input device but has no wrist support). In FIG. 23, mouse and keyboard wrist rest devices 10 are shown, and they are of the type discussed immediately above. However, the securement approach can be used with any embodiment, including other embodiments discussed herein, and the illustrated devices 10 are not limiting. In FIG. 23, each frame 24 has one or more (shown as a pair) of retainer receiving openings 120. As shown, the illustrated embodiment has four openings 120 on each frame 24, a pair at each lateral end, which enables the securement to occur at either end for left or right handed users. Likewise, a pair of retainers 126 are also included. Each opening 120 may have a “dumbbell” (also called a figure-8 or snowman shape) with two wide portions, the inner one at 121 and the outer one at 122, and a narrower slot 124 connecting the wider portions 121, 122. As another approach, the two portions 121, 122 could be separate openings with no slot connecting them. The wider portions are preferably round, and more preferably of circular shape for easier rotation of the retainer 126. The retainers 126 have a similar shape to the openings with wider portions 127, 128 connected by a narrower bridge portion 129, although other shapes may be used. In the illustrated embodiment, each retainer 126 is rotatably connected to a corresponding outer wider portion/opening 122 of first one of the devices 10 (for example, they could just be included only on the keyboard wrist rest device, but it could be either, or they may be included as separate parts and the end user can choose which device to which they are initially connected). Each retainer 126 has a pair of posts each with a head, flange or other securement feature (not shown) extending upwardly therefrom, and in the illustrated embodiment they extend up from the wider portions 127, 128. The rotatable connection to the first device 10 (e.g., the keyboard one) is established by inserting the securement feature on portion 127 into the corresponding wider portion/opening 122, with the head or flange being oversized relative to the wider portion/opening 122 to secure the retainer 126 thereto for rotation. As an option, during non-use, the retainer 126 can be rotated to point laterally inwardly on the same first device so the post and its securement feature on the other wider portion 128 can be inserted into the associated inner wider portion 121 on the same first device 10 in the same manner, thus putting the retainer 126 in a storage position out of view. For securement of the second device, each retainer 126 can be rotated to point laterally outwardly as illustrated, and the post and its securement feature on the other wider portion 128 can be inserted into the associated outer wider portion 122 on the other second device 10 in the same manner, thus securing them together. These retainers 126 may optionally be further supplemented with anti-slip material like the pads 132, thus enabling them to perform the dual function of connecting and providing slip resistance.

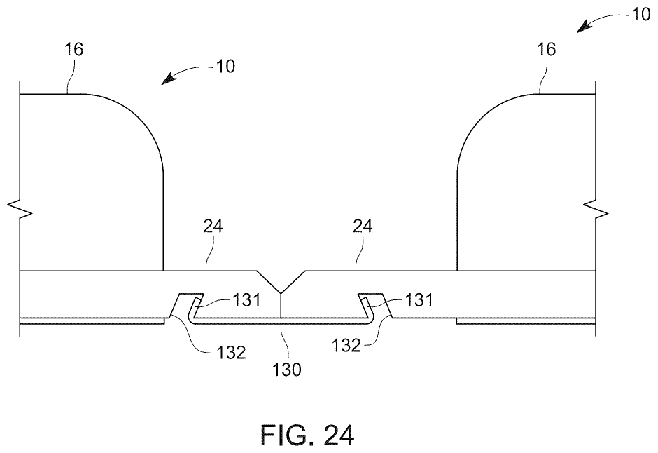

FIG. 24 shows a variation where clips 130, such as spring clips, are engaged with openings 132 in the underside of the adjacent wrist rest devices to secure them together, thus holding them together as a unit. The clips 130 have engaging fingers 131 or other insertion elements that extend from opposing lateral ends thereof and are received in the openings 132. The clips 130 can be removed, thus allowing the devices to also be used separately. That choice may depend on user's preference.

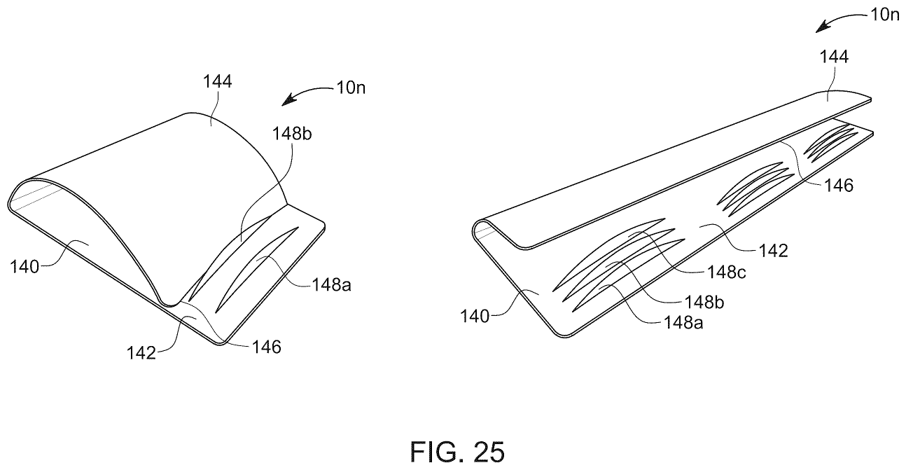

FIG. 25 provides a collapsible wrist rest device 10n, one of which is shown with a mouse use size and the other of which is shown with a keyboard size. The device 10n comprises a sheet material comprises a base portion 140 having an upper surface 142 and a bottom surface (not visible) for engaging a work surface and supporting the wrist rest device 10n. The device 10n also has a wrist support portion 144. The base portion 140 and the wrist support portion 144 are formed integrally together as one continuous piece. For example, they may be formed by injection molding, stamping, extrusion or any other suitable process. Any material may be used, and suitable materials include those mentioned above with respect to FIG. 19, which also uses a bowed configuration approach, albeit in a device that is fully disassembled. As illustrated, a distinct fold line may be created where the two portions meet, although in some embodiments the transition may be more gradual. A retention structure is provided on the upper surface 142 of the base portion for engaging a free edge 146 of the wrist support portion 144. The illustrated embodiments have three such retention structures 148a, 148b and 148c, and any number may be used. As can be appreciated from the prior discussion for FIG. 21 the different retention structures allow different levels of pre-tensioning and resilient support (the degree of bowing) to be selected for the wrist support portion 144. Each retention structure 148a, 148b and 148c is positioned such that engagement of the free edge 146 therewith pre-tensions the wrist support portion in the bowed configuration to provide resilient support to a user's wrist. The free edge 146 of the wrist support portion 144 can be disengaged from the interlocking structure 148a, 148b, 148c to allow the wrist support portion 144 to assume a substantially flatter configuration for collapsing of the wrist rest device. As used herein, substantially flat refers to a configuration that may be truly flat, or may be close to flat, recognizing that some materials may experience slight plastic deformation and retain some curvature after a period of usage. That, however, is still considered substantially flat and a person of ordinary skill in the art will readily understand that term, particularly in the context of the collapsibility providing a much smaller size.

Thus, the embodiments of FIGS. 19-21 broadly provide different approaches to a collapsible wrist rest device. Each device comprises a base portion (140 in FIG. 25 and the frame 24k-m in FIGS. 19-21) and a wrist support formed of a sheet material. In FIGS. 19-21 the wrist support is a separate component, whereas in FIG. 25 the same sheet material provides both the base and the wrist support as portions thereof. In each, the retention structure is provided on the upper surface of the base portion and has at least one surface for engaging at least one free edge of the wrist support portion. In FIG. 25, only a single free edge is engaged because the other end of the wrist support portion is already part of the sheet material; whereas in FIGS. 19-21 both opposing edges of the wrist support's sheet material are free edges. The retention structure in each is also positioned such that engagement of the at least one free edge therewith pre-tensions the wrist support portion in a bowed configuration to provide resilient support to a user's wrist. In FIG. 19 only one retention structure for the single free edge is used (although multiple may be used for that same single free edge); whereas in FIGS. 19-21 the retention structure includes one (or more) for each free edge. Thus, in each the free edge or edges can be disengaged from the interlocking structure(s) to allow the wrist support to assume a substantially flatter configuration for collapsing of the wrist rest device.

As mentioned above, the materials used may be of the type suitable for recycling and components of the device 10 may be formed from other types of materials that are environmentally favorable. For example, any or all components may be made of bioplastics, which are plastics created from plant, animal or microorganism products, instead of petroleum products (e.g., oil or gas). Examples include PHAs, PLA, starch blend polymers, cellulose-based plastics, lignin-based polymer composites, Also, any or all components may be made from a material that is compostable, which means it is able to be broken down by biological processes into its organic constituents without an amount of toxic residue that would adversely impact the ability of the finish compost to support plant growth. For plastics, the ASTM Standard D6400 and D6868 (in effect of the effective filing date of this application) set forth specifications that must be met to label a plastic as “compostable” and uses controlled processes. The materials used may also be home compostable, which are a class that can be composted without industrial composting facilities. There is no US standard for home compostable plastics and reference may be made to the Australian standard AS 5810 (“biodegradable plastics suitable for home composting”). Biodegradable materials may also be used as well, and these are materials that break down to their organic constituents under processes and conditions natural to the biosphere by microbial breakdown, examples of which for plastics include PGA, PBS, PCL, PVA, PVOH, and PBAT. Biodegradable plastics are not necessarily compostable, as some plastics can be composted under controlled conditions (i.e, higher heat, pressure, nutrient or microorganism conditions) that are not found naturally, but some may be both compostable and biodegradable. Combinations of these materials may be used as well, such as material of one type for one component and a material of another type for the other. Likewise, the material for one component (e.g., the frame 24) may be of the type that is recyclable but not biodegradable, compostable/home compostable, or a bioplastic (or it may also be non-recyclable), while the other component (e.g., the wrist support 16) is biodegradable, compostable/home compostable, or a bioplastic, thus improving environmental friendliness in part. The standards mentioned are incorporated herein by reference.

The principles of the embodiments discussed herein for a wrist rest may be applied to ergonomic body support devices in other fields as well, including non-analogous fields. For example, embodiments using a frame and deformable body part support may be applied to a lumbar rest device, with the support being shaped as a lumbar support pad and the frame designed to be attached to (or included as part of) a chair's seat back for mounting and retaining the lumbar support pad to support the user's lumbar back region. The frame when separate may, for example, be attached by a strap, bolts, screws, or other fasteners for positioning at the back of a chair. The same principles may be applied to a larger back rest or seat pan. In some embodiments, the frame, such as a frame of ABS material, could be the frame portion of a supplemental and or primary chair frame, while the elastomeric element could be the primary and or secondary cushion. Also, the embodiments using a frame and deformable support may be applied to a foot rest, with the support being shaped as a foot pad and the frame designed to be attached to (or included as part of) a base that engages the floor for providing the base unit of a foot rest. These embodiments may be practiced most preferably using the elastomeric support design with internal ribs, walls or columnar cells as discussed above. These embodiments may provide the non-limiting advantage of enabling the support part to be replaced, which typically experiences more wear than the structural frame part (e.g., the foot rest base or a frame attached to or included in a chair). The directional references used herein remain the same in a relative sense, with the upward direction being the direction that faces the user during usage and the other directions having their same orientation with respect to the upward direction (e.g. the forward wall of a lumbar support that engages the user's lower back would be considered the upper wall).

Although various embodiments have been illustrated and described, various features of those embodiments may be applied to other embodiments. Although certain such examples have been mentioned, those are not exclusive and the application contemplates combinations of different features from separately illustrated embodiments as additional embodiments.

The disclosed embodiments have been provided solely to illustrate examples of the structural and functional principles of the present application and should not be considered limiting. To the contrary, the present application includes all modifications, alterations, substitutions, and/or equivalents within the spirit and scope of the appended claims.

What is claimed:

1. An ergonomic support device comprising:
a body part support formed of deformable material for providing resilient support to a user's body part, the body part support having an upper wall and forward and rearward edge portions extending in a lateral direction,
a frame having a body part support receiving space for receiving and removably securing the body part support to the frame, the frame engaging at least the forward and rearward edge portions of the body part support to prevent deflection of the edge portions away from one another.

2. The ergonomic support device of claim 1, wherein the device is a wrist rest device for use with a manually operated computer input device and the body part support is a wrist support formed of the deformable material for providing resilient support to a user's wrist, and wherein the body part support receiving space of the frame is a wrist support receiving space for receiving and removably securing the wrist rest support to the frame.

3. The ergonomic support device of claim 2, wherein the frame includes a device support pad extending forwardly away from the wrist support for supporting the computer input device thereon.

4. The ergonomic support device of claim 3, wherein the wrist support and the frame have corresponding mating surfaces for removably securing the wrist support to the frame.

5. A wrist rest device for use with a manually operated computer input device, comprising:
a wrist support formed of deformable material for providing resilient support to a user's wrist, the wrist support having an upper wall for engaging the wrist, the wrist support also having forward and rearward walls extending in a lateral direction with forward and rearward edge portions,
the wrist support further comprising a plurality of vertical members extending downwardly from the upper wall in an interior of the wrist support between the forward and rearward walls, the vertical members being configured to engage a work surface on which the wrist support is placed to resist downward deflection of the upper wall.

6. The wrist rest device of claim 5, wherein the vertical members are cell walls forming a plurality of columnar cell structures open to a bottom of the wrist support.

7. The wrist rest device of claim 6, wherein one or more cell walls are provided with an air passage to permit air to escape from a cell interior as the wrist support is compressed downward.

8. The wrist rest device of claim 6, wherein the air passages are notches or recesses on bottom edges of the one or more cell walls.

9. The wrist rest device of claim 6, wherein the air passages are notches or recesses between cell walls.

10. The wrist rest device of claim 7, wherein each air passage is configured to permit air to enter the cell interior as the wrist support rebounds upwardly.

11. The wrist rest device of claim 6, wherein the columnar cell structures are formed in a honeycomb configuration.

12. The wrist rest device of claim 7, wherein the columnar cell structures are formed in a honeycomb configuration.

13. The wrist rest device of claim 6, further comprising a filler material included within the columnar cell structures.

14. The wrist rest device of claim 11, further comprising a filler material included within the columnar cell structures.

15. The wrist rest device of claim 5, wherein the plurality of vertical members are tapered, with a thicker upper portion connected to the upper wall and a thinner lower portion that has the bottom edge that engage the work surface.

16. The wrist rest device of claim 15, wherein the tapering of the vertical members is configured to provide a gradual increase in resistance to downward deflection of the upper wall wherein a bending focus gradually rises such that the bending occurs at higher points on the cell walls, which are increasingly thicker.

17. The wrist rest device of claim 5, wherein the plurality of vertical members extend downwardly from the upper wall such that when the upper wall is undeflected the vertical members are spaced upwardly from a bottom plane of the wrist support so as to be spaced above the work surface.

18. The wrist rest device of claim 17, wherein bottom edges of the vertical member follow a curved or arched shape.

19. The wrist rest device of claim 6, wherein the plurality of vertical members extending downwardly from the upper wall such that when the upper wall is undeflected the vertical members are spaced upwardly from a bottom plane of the wrist support so as to be spaced above the work surface.

20. The wrist rest device of claim 19, wherein bottom edges of the vertical member follow a curved or arched shape.

21. The wrist rest device of claim 5, wherein the plurality of vertical members includes two or more parallel walls within the wrist support interior that extend parallel to the forward and rearward walls, the parallel walls being connected to the inner surface of the upper wall for additional support against deflection of the upper wall.

22. The wrist rest device of claim 5, wherein said vertical members extend below a bottom plane of the wrist support such that when the wrist support is placed on a work surface the vertical members are pretensioned under bending stress.

23. The wrist rest device of claim 21, wherein said walls extend below a bottom plane of the wrist support such that when the wrist support is placed on a work surface the walls are pretensioned under bending stress.

24. The wrist rest device of claim 23, wherein bottom ends of the walls are provided with projections and recesses, and wherein for each pair of adjacent walls the projections on one wall are aligned with the recesses on the other wall such that the projections and notches can engage with one another and inhibit the walls from sliding over one another if the walls deflect towards one another as the upper wall is pressed down by the user.

25. The wrist rest of claim 5, wherein the plurality of vertical members are a plurality of ribs extending downwardly from the upper wall, wherein the ribs are configured to deflect to provide resilient support against the downward deflection of the upper wall.

26. The wrist rest of claim 25, wherein the ribs are arranged in rows parallel to the forward and rearward walls such that each adjacent pair of rows has the ribs staggered or offset with respect to the other in the direction parallel to the forward and rearward walls.

27. The wrist rest of claim 26, wherein the ribs of the rows are arranged to be generally aligned in diagonal directions.

28. A wrist rest device according to claim 2 wherein the wrist rest is molded as one integral piece.

29. A wrist rest device according to claim 2, wherein at least the deformable material of the wrist support is selected from at least one of the group consisting of: a bioplastic, compostable material, home compostable material, and a biodegradable material.

30. A wrist rest device according to claim 5 wherein the wrist rest is molded as one integral piece.

31. A wrist rest device according to claim 5, wherein at least the deformable material of the wrist support is selected from at least one of the group consisting of: a bioplastic, compostable material, home compostable material, and a biodegradable material.

32. A collapsible wrist rest device comprising:
a base having an upper surface and a bottom surface for engaging a work surface and supporting the wrist rest device;
a wrist support formed of a sheet material;
at least one retention structure provided on the upper surface of the base for engaging at least one free edge of the wrist support, wherein the at least one retention structure is positioned such that engagement of the at least one free edge therewith pre-tensions the wrist support in a bowed configuration to provide resilient support to a user's wrist;
wherein the at least one free edge of the wrist support can be disengaged from the at least one retention structure to allow the wrist support to assume a substantially flatter configuration for collapsing of the wrist rest device.

33. A collapsible wrist rest device according to claim 32 wherein the base is also formed of the sheet material such that the base and the wrist support are each a portion of the sheet material, wherein the base portion and the wrist support portion are formed integrally together as one continuous piece;
wherein the at least one retention structure is provided on the upper surface of the base portion for engaging a free edge of the wrist support portion and is positioned such that engagement of the free edge therewith pre-tensions the wrist support portion in a bowed configuration to provide resilient support to a user's wrist;
wherein the at least one free edge of the wrist support portion is a single free edge and the at least one interlocking structure includes at least one interlocking structure positioned to engage the single free edge to pre-tension the wrist support portion in a bowed configuration.
